(19) United States
(12) Patent Application Publication
(10) Pub. No.: US 2009/0163200 A1
(43) Pub. Date: Jun. 25, 2009

(54) Mobile device supporting walkaway conversation establishment

(75) Inventors: Andrew Christian, Lincoln, MA (US); Brian Avery, Lexington, MA (US)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/004,543

(22) Filed: Dec. 20, 2007

(51) Int. Cl. H04Q 7/20

(52) U.S. Cl. 455/426.1; 455/414.1

(57) ABSTRACT

An apparatus includes a data processor; a user interface; a first communication interface through which a call may made; a second communication interface; and a memory that stores information received through the second communication interface. The information is received from at least one mobile communication device when disposed in proximity to the apparatus, such as being received through a Bluetooth link. The data processor is configurable to operate with the user interface, the memory and the first communication interface to initiate a call to the at least one mobile communication device using the stored information. The call is initiated when the at least one mobile communication device is no longer disposed in proximity to the apparatus. In the exemplary embodiments the stored identification-related information enables a user of the apparatus to continue a face-to-face conversation conducted with a user of the at least one second mobile device after the user of the second mobile device is no longer in proximity to the user of the apparatus.

### TECHNICAL FIELD

The exemplary and non-limiting embodiments of this invention relate generally to communication systems, methods, devices and computer programs and, more specifically, relate to techniques for operating a mobile device to establish a connection with another mobile device.

### BACKGROUND

A problem can arise when two (or more) people in a common location are holding a conversation that they wish to continue after they physically separate. Using current technology one person would need to activate his/her cell phone, look up the other person in the phone book (assuming that the other person had an entry in the phone book), place the phone call, and wait for an answer. This is an involved process and can be difficult to perform accurately when a person is walking or driving.

What is needed is a technique to solve the foregoing and other problems.

### SUMMARY OF THE EXEMPLARY EMBODIMENTS

The foregoing and other problems are overcome, and other advantages are realized, in accordance with the non-limiting and exemplary embodiments of this invention.

In accordance with a first aspect of the exemplary embodiments of this invention a method includes detecting via a wireless link a presence of at least one second mobile device within proximity of a first mobile device, where the detected at least one second mobile device is associated with a user who is involved in a conversation with a user of the first mobile device; storing identification-related information received from the at least one second mobile device in a memory of the first mobile device; and initiating a call to the at least one second mobile device using the stored identification-related information so as to continue the conversation between the users when the at least one second mobile device is no longer within proximity of the first mobile device.

In accordance with a further aspect of the exemplary embodiments of this invention a computer-readable memory medium stores program instructions the execution of which results in operations that comprise detecting via a wireless link a presence of at least one second mobile device within proximity of a first mobile device, where the detected at least one second mobile device is associated with a user who is involved in a conversation with a user of the first mobile device; storing identification-related information received from the at least one second mobile device in a memory of the first mobile device; and initiating a call to the at least one second mobile device using the stored identification-related information so as to continue the conversation between the users when the at least one second mobile device is no longer within proximity of the first mobile device.

In accordance with a further aspect of the exemplary embodiments of this invention there is provided an apparatus that includes a data processor; a user interface; a first communication interface through which a call may be made; a second communication interface; and a memory that stores information received through the second communication interface, the information being received from at least one mobile communication device when disposed in proximity to said apparatus. The data processor is configurable to operate with the user interface, the memory and the first communication interface to initiate a call to the at least one mobile communication device using the stored information to continue a conversation between a user of the apparatus and a user of the at least one mobile communication device. The call is initiated when the at least one mobile communication device is no longer disposed in proximity to the apparatus.

In accordance with another aspect of the exemplary embodiments of this invention there is provided an apparatus that includes means for detecting via a wireless link a presence of at least one second mobile device within proximity of a first mobile device; means for storing identification-related information received from the at least one second mobile device in a memory of the first mobile device; and means for initiating a call to the at least one second mobile device via a communications network using the stored identification-related information, thereby enabling a user of the apparatus to continue a face-to-face conversation conducted with a user of the at least one second mobile device after the user of the second mobile device is no longer in proximity to the user of the apparatus.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a block diagram of a device that is suitable for practicing the embodiments of this invention.

FIG. 2 is a block diagram of a network within which the device of FIG. 1 may be used.

FIG. 3 is a logic flow diagram that illustrates a method, and the result of execution of computer program instructions by the data processor shown in FIG. 1.

### DETAILED DESCRIPTION

One may refer to the type of interaction described above, where two or more persons involved in a conversation need to physically separate, as a “walkaway conversation”. This type of interpersonal interaction occurs with remarkable frequency in daily life.

The exemplary embodiments of this invention provide signaling and automatic call set up for mobile phone conversations that facilitate continuing a walkaway conversation.

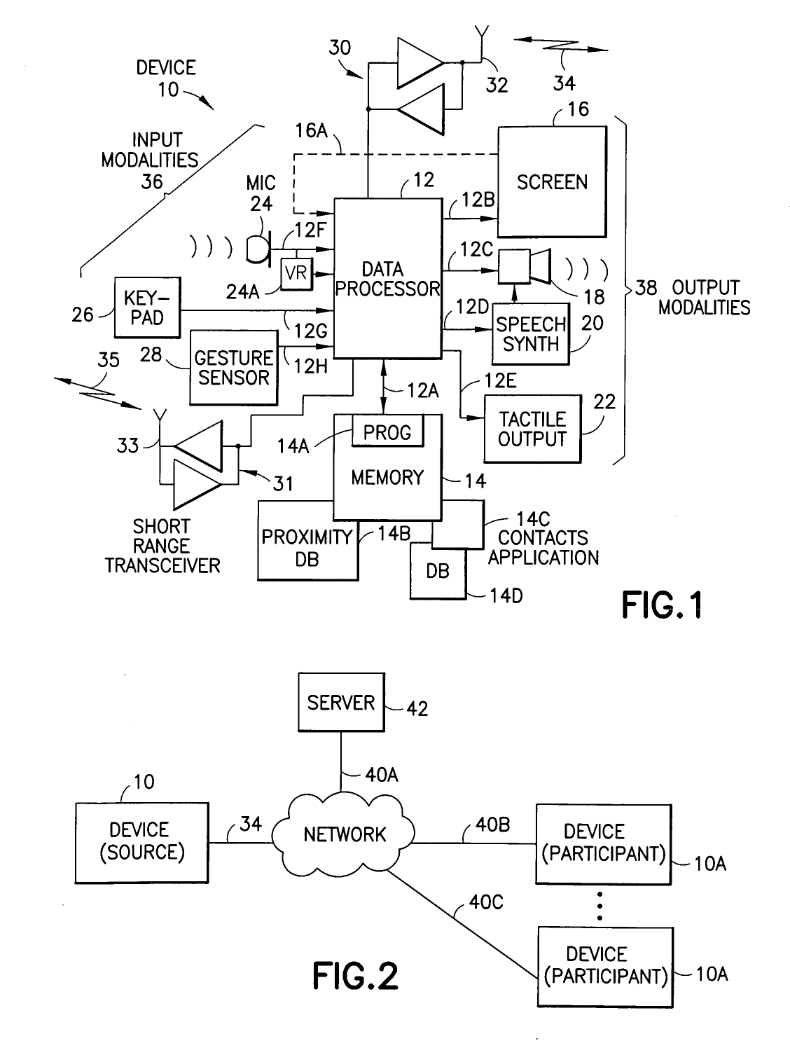

Reference is made to FIG. 1 for illustrating a simplified block diagram of an exemplary embodiment of an electronic device 10 that is suitable for use in practicing the exemplary embodiments of this invention. In FIG. 1 device 10 includes a data processor 12 that is coupled through a bus 12A with a memory 14 that stores a program (PROG) 14A of instructions that are executable by the data processor 12. The device 10 may further include a plurality of input and output devices and subsystems, referred to herein also as input modalities 36 and output modalities 38. As exemplary output devices there may one or more of a visual display screen 16, such as an LCD or a plasma display screen, an acoustic output transducer such as a loudspeaker 18, a speech synthesis subsystem 20 having an output that can be played through the loudspeaker 18 (or through another acoustic output transducer), and a tactile output device or transducer 22, such as a vibratory device (e.g., a piezoelectric transducer). These output devices are coupled to corresponding output paths 12B, 12C, 12D and 12E from the data processor 12. As exemplary input devices there may one or more of an acoustic input transducer such as a microphone 24, an associated speech or voice recognition function (VR) 24A, a keypad or keyboard 26 and a gesture sensor 28, such as a device that is responsive to a rotation about at least one axis and/or to a force applied by a user's finger or stylus, such as when making a tapping gesture. These input devices are coupled to corresponding input paths 12F, 12G and 12H to the data processor 12. If the screen 16 is a touch-sensitive screen then there may also be an input 16A from the screen 16 to the data processor 12. In this case the input to the data processor may represent activation of a virtual key or button by the user, as opposed to the use of the keypad/keyboard 26 where the input signal may represent activation of a physical key or button (such as an alphanumeric key or a physical ‘soft’ key or button). The microphone 24 may be coupled with the speech recognition functionality of the device 10 (the VR 24A) whereby a word or words spoken by the user can be interpreted by the data processor 12 as representing a command.

It should be appreciated that the data processor block 12 may actually comprise a number of circuit types, in addition to a data processor per se, such as analog-to-digital converters and digital-to-analog converters that support the operation of the various input modalities 47 and output modalities 48.

In the exemplary embodiments the device 10 has user communication capabilities, and includes a suitable transceiver 30, such as a radio frequency transceiver coupled with at least one antenna 32 for conducting wireless communications through a bidirectional long range radio frequency link 34 (e.g., a link to a cellular communication network). The device 10 also includes a second transceiver 31 coupled with at least one antenna 33 to a short range radio frequency link 35, such as a low power radio frequency link that may be a Bluetooth™ link. In other embodiments the transceiver 31 may be optically based and may then include suitable optical source and detector components, such as an infrared emitter and an infrared detector.

It should be noted that the various input modalities 36 and output modalities 38 are exemplary, and not all may be present in a given implementation. For example, the exemplary embodiments of this invention may be used with just the display screen 16 and the keypad/keyboard 26, or with just the display screen 16 if the screen is touch sensitive to permit the user to enter information and commands.

The PROG 14A is assumed to include program instructions that, when executed by the data processor 12, enable the electronic device 10 to operate in accordance with the exemplary embodiments of this invention, as will be discussed below in greater detail.

In general, the various embodiments of the device 10 can include, but are not limited to, cellular phones, personal digital assistants (PDAs) possibly having wireless communication capabilities, portable computers possibly having wireless communication capabilities, GPS devices possibly having wireless communication capabilities, image capture devices such as digital cameras possibly having wireless communication capabilities, gaming devices possibly having wireless communication capabilities, music storage and playback appliances possibly having wireless communication capabilities, Internet appliances permitting wireless or wired Internet access and browsing, as well as portable units or terminals that incorporate combinations of such functions.

The exemplary embodiments of this invention may be implemented by computer software executable by the data processor 12, or by hardware, or by a combination of software and hardware (and firmware).

The memory 14 may be of any type suitable to the local technical environment and may be implemented using any suitable data storage technology, such as semiconductor-based memory devices, flash memory, magnetic memory devices and systems, optical memory devices and systems, fixed memory and removable memory. The data processor 12 may be of any type suitable to the local technical environment, and may include one or more of general purpose computers, special purpose computers, microprocessors, digital signal processors (DSPs) and processors based on a multi-core processor architecture, as non-limiting examples.

The memory 14 is shown as including computer program code that implements a proximity database (DB) 14B as well as a Contacts application 14C and associated database (DB) 14D. The use of the proximity database 14B is discussed below.

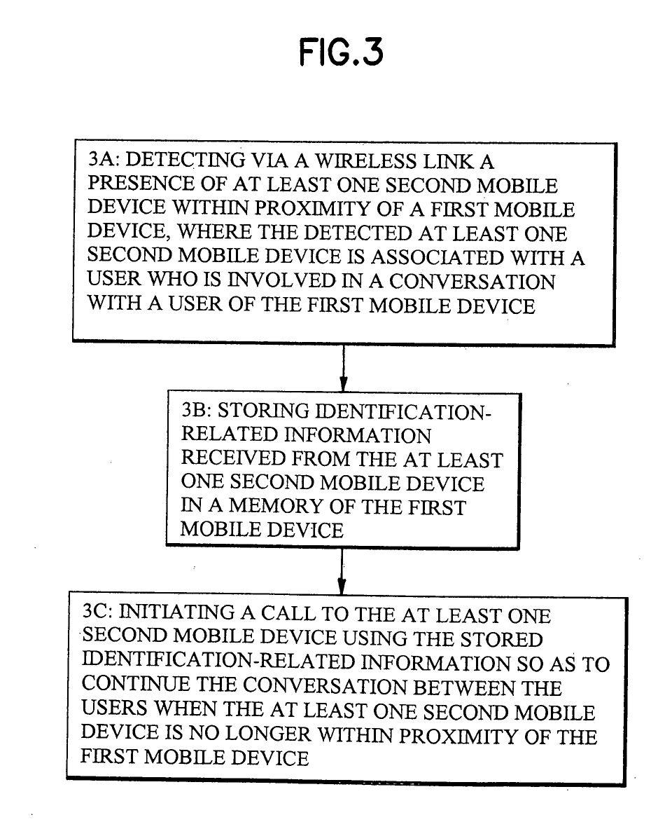

FIG. 2 depicts the device 10 connected to a network 40 via the link 34 (a wireless or wired link). In this example, the device 10 may be referred to as the source device as it initiates the continuation of the walkaway conversation. The network 40 provides connectivity to one or more other devices 10A (which may or may not be constructed as the device 10 shown in FIG. 1), and which may be referred to as walkaway conversation participant devices 10A. A server 42 may also be connected to the network 40, where the server 42 may facilitate the setup of communications with other members of the walkaway conversation (the participant devices 10A), as discussed below.

The network 40 may represent, as non-limiting examples, a wireless network (e.g., a cellular network), a local area network (LAN), a wireless local area network (WLAN), or the Internet. The network 40 may also represent plural network types that are interconnected together. For example, the source device 10 may be connected through a first cellular network, one of the participant devices 10A may be connected via a wired Internet interface (e.g., a cable modem), another participant device 10A may be connected via a WLAN, and yet another participant device 10A may be connected via a second cellular network that differs in location and possibly access technology type from the first cellular network. In other words, the specifics of the connectivity between the source device 10 and the participant devices 10A is not germane to an understanding (or the implementation) of this invention, and the network 40 is assumed to include whatever interworking mechanisms are needed to permit communication to occur between the source device 10 and one or more of the participant devices 10A.

The exemplary embodiments of this invention provide and operate in accordance with proximity-initiated data exchange, human interface, and call setup.

It is noted that Object Exchange (OBEX) is a set of protocols allowing objects such as vCard contact information and vCalendar schedule entries to be exchanged using either IrDA or Bluetooth. The Symbian™ OS implements IrDA for exchange of vCards, for example between communication devices.

A standard known as vCard defines the format of an electronic business card. All devices supporting vCard can exchange information such as phone numbers and addresses. For example, a user with a vCard-aware phonebook application on a handheld computer can easily transfer names and phone numbers to a vCard-aware mobile phone. vCards can also be transferred between mobile phones.

Two publications of interest to vCard technology include RFC 2425, “A MIME Content-Type for Directory Information”, T. Howes, M. Smith, F. Dawson, September 1998, and RFC 2426, “vCard MIME Directory Profile”, F. Dawson and T. Howes, September 1998.

For the purposes of describing the exemplary embodiments of this invention, proximity-initiated data exchange occurs when one or more mobile communication devices 10, 10A detect the presence of another mobile communication device and record in the memory 14 information about the other device. The proximity database 14B may be considered for convenience as the repository of this device-related information. The detection and interchange of information may occur through the transceiver 31 and antenna 33. This activity can occur continuously. The information recorded may include sufficient information to place a phone call to the other device 10, or may include only enough information so that a data repository, such as the server 42 shown in FIG. 2, can be consulted to enable the placement of the phone call.

The human interface allows the user to rapidly continue a face-to-face conversation with a minimum of effort. For this purpose the person may need to select a most likely device to communicate with (there may be more than one). This selection may be done manually from a list of presented devices, optionally augmented by useful metrics. The selection may be made with a voice command, gesture, touch, or key entry using one or more of the input modalities 36. Exemplary metrics may include, but are not limited to, most recently seen, most frequently seen, devices that the user has frequently had walkaway conversations with in the past, and/or priority presence in a phone book (e.g., in the contacts database 14D).

Call setup occurs in response to the person selecting the conversation to continue. Call setup may be direct if the contact information of the other device(s) 10A is known (e.g., a phone number or a SIP URL (session initiation protocol uniform resource locator)). If the contact information is not known by the user of the device 10, but the other device(s) 10A are within short-range communication of the transceiver 31, the devices 10, 10A may request permission from their respective users to exchange contact information. If short-range communication is not possible, communication may still be established by going through a third party service that provides anonymity (possibly implemented by the server 42).

Described now are several exemplary and non-limiting use cases that aid in understanding various aspects of this invention.

Use Case #1: Alice and Bob are chatting in a hallway. They already have each other's contact information in their respective mobile devices 10, such as in the contacts database 14D. When they begin to separate Alice activates her device 10, which then presents a top-level choice of “continue the conversation with Bob?” Alice affirms this choice using one of the input modalities 36 and the phone call to Bob's device 10 is originated.

Use Case #2: Alice and Bob have recently joined the same construction company and are walking a job site. They have not yet exchanged telephone numbers, but because they have been walking together for several minutes their respective mobile devices 10 have exchanged some anonymous information via the transceivers 31. Bob and Alice need to separate to examine the construction progress, but before they go their different ways, Bob activates his mobile device 10 and selects as an option “continue conversation with local person”. Alice authorizes the conversation on her mobile device 10, and the two devices 10 begin a voice conversation.

Use Case #3: Alice and Bob are chatting in a pub. They have never met before, but their mobile devices 10 have exchanged public cryptography keys via the transceivers 31. When (or before) they separate, Bob activates his device 10 and selects an option “continue conversation”. Bob's mobile device 10 contacts a central service that stores Alice's private phone number. The central service, which may be embodied in the server 42, verifies that Bob has cryptographically signed, timestamped anonymous contact information from Alice's mobile device 10, and places the phone call to Alice. Alice sees the incoming call from the service and has a choice to accept or deny the conversation originated from Bob's mobile device 10. In this embodiment the timestamp may have an optional validity period associated therewith, after which the privacy service that may be embodied in the server 42 does not respond to the request from Bob's phone to contact Alice. The cryptographic signature ensures that the information originated from Alice's mobile device 10.

Use Case #4: Alice, Bob and Charlie are speaking together in an elevator. Their mobile devices 10 recognize each other as a common conversation group. This can be achieved automatically via the transceivers 31, and by a recognition that a plurality of mobile devices 10 were in close proximity for some sustained period of time (e.g., a period longer than what would normally be the case had the devices simply passed each other in a hallway or on the street). Assume that Charlie exits the elevator on a different floor than Alice and Bob, and that Charlie then activates his mobile device 10 and selects as an option “continue conversation group with Alice and Bob”. In response, Charlie's mobile device 10 automatically sets up a three-way conference call with the mobile devices of Alice and Bob.

The proximity-initiated data exchange may be implemented using Bluetooth™ technology via the transceiver 31, and by the use of public/private key cryptography. A software application executing on the device 10 periodically (e.g., once per minute) activates the Bluetooth™ transceiver 31 and performs a Bluetooth™ scan. During the scan service discovery is performed on any detected devices that have not been previously seen. Service discovery searches for another device or devices that support the walkaway protocol. If another walkaway device is located then the devices exchange walkaway-related identification records. A walkaway identification record may include, but is not limited to:

1. Bluetooth™ device name;
2. Bluetooth™ MAC (medium access control) identification number;
3. Anonymity service contact number (optional); and
4. Timestamp signed with a private walkaway cryptography key of the mobile device 10.

Any received walkaway identification records and other information may be stored in the proximity database 14B.

The human interface allows a person to rapidly establish communication with a just-seen walkaway-compatible device 10. In a simplest form it may appear as a first choice available when the person activates his or her mobile device 10. For example, in the case of a mobile phone that has a cover that opens and closes, when the phone cover is opened a dialog box asking “establish communications with WALKAWAY” may be shown on the display screen 16 (where WALKAWAY is replaced by the name of the other person if that person's name can be established from the Bluetooth™ record stored in the proximity database 14B). A single button push or other type of user input is all that is then needed to establish the communication with the participant device 10A.

In more complex environments more than a single walkaway-compatible device 10 may have been recently detected. A list of metrics may be applied against the list of possible walkaway-compatible devices to order them in likelihood of being potential devices to communicate with. Metrics applied may include, but are not limited to:

an amount of time that a particular walkaway-compatible device was seen (i.e., for how long was the device in close proximity to the device 10);
how long it has been since a particular walkaway-compatible device was last seen; the frequency of contacting a particular walkaway-compatible device for establishing a walkaway communication;
the total number of times that a particular walkaway-compatible device has been previously contacted for establishing a walkaway communication; and/or
the received signal strength determined during the Bluetooth™ data scan, where typically a device having a high signal strength is one in closer proximity to the device 10 than a device having a low signal strength, and thus is more likely to be a potential walkaway group participant or member.

If more than one walkaway-compatible device is a potential communication target (i.e., is a potential participant device 10A), a walkaway dialog box displayed on the display screen 16 may pre-select, based on the metrics, a most likely target or target devices. However, it is preferred that the user has the ability to override the potential participant device(s) 10A that are pre-selected by the walkaway application of the device 10.

Call initiation begins when one or more persons choose to start the phone call. There are several possible scenarios that may apply such as: known contact information (phone number or SIP URL), unknown information but device is within Bluetooth™ range (e.g., within about 10 meters), and unknown information and device out of Bluetooth™ range. In the first scenario, if the other device is recognized and a phone number is already known for that device (for example, by looking up a table that maps Bluetooth™ MAC address to phone number), then the phone call may be directly placed.

If the contact information is not known, the initiating device 10 attempts contact using Bluetooth™ via the transceiver 31 and requests a contact number. The target device presents a dialog box to the user of the target device and requests permission to provide the requested contact information. The contact information may be the phone number of the device itself, or it may be an authorization number for the anonymity service implemented at the server 42 (as specified in the original Bluetooth™ exchange). In either case the initiating device 10 is enabled to place the phone call (assuming that the user of the target device authorizes providing the contact information, which the user may not).

If the phone number is not known and the devices are out of Bluetooth™ range, the device 10 may call the anonymity number provided in the initial Bluetooth™ exchange and pass the cryptographically signed, timestamped anonymous contact information. The anonymity service verifies that the signed timestamp was generated by the target device and verifies that the timestamp is within an acceptable temporal range. The temporal range may be, for example, five minutes, or any value that is reasonable for the circumstances. If a match is found, i.e., the signed timestamp is verified, the phone call is sent from the source device 10 to the receiving participant device 10A. Appropriate caller-id information may be presented to inform the user of the participant device 10A of the nature of the incoming call. During the call setup and connection the calling person preferably does not gain knowledge of the direct contact information (e.g., phone number or email address) of the called person, as this information is maintained at the anonymity service.

There are a number of advantages that can be realized by the use of the exemplary embodiments of this invention. For example, the barrier to making calls is decreased as the device 10 may automatically identify possible participant devices 10A for a walkaway conversation, and may also automatically ascertain the contact information needed to place the call, thereby removing these tasks from the user of the device 10.

Referring to FIG. 3, in accordance with a method and the execution of computer program instructions stored in a computer-readable memory medium, at Block 3A there is performed a step of detecting via a wireless link a presence of at least one second mobile device within proximity of a first mobile device, where the detected at least one second mobile device is associated with a user who is involved in a conversation with a user of the first mobile device. At Block 3B there is a step of storing identification-related information received from the at least one second mobile device in a memory of the first mobile device. At Block 3C there is a step of initiating a call to the at least one second mobile device using the stored identification-related information so as to continue the conversation between the users when the at least one second mobile device is no longer within proximity of the first mobile device.

The various blocks shown in FIG. 3 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but some examples, the use of other different, similar or equivalent techniques for interacting with the user to identify possible participant devices for a walkaway conversation may be attempted by those skilled in the art. Further, it should be appreciated that the exemplary embodiments of this invention are not limited for use with only Bluetooth™ technology for detecting possible participant devices for a walkaway conversation. All such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
detecting via a wireless link a presence of at least one second mobile device within proximity of a first mobile device, where the detected at least one second mobile device is associated with a user who is involved in a conversation with a user of the first mobile device;
storing identification-related information received from the at least one second mobile device in a memory of the first mobile device; and
initiating a call to the at least one second mobile device using the stored identification-related information so as to continue the conversation between the users when the at least one second mobile device is no longer within proximity of the first mobile device.

2. The method as in claim 1, where the stored identification-related information comprises a telephone number.

3. The method as in claim 1, where the stored identification-related information comprises information needed to access a database of contact information to enable the initiation of the telephone call.

4. The method of claim 3, where the database comprises part of the first mobile device, or where the database is external to the first mobile device and is accessed through a communication network.

5. The method as in claim 1, where the stored identification-related information comprises cryptographically signed, timestamped anonymous contact information that is transmitted to a remote server to enable the initiation of the telephone call without divulging direct contact information of the user of the second mobile device to the user of the first mobile device.

6. The method as in claim 1, where initiating comprises determining a list comprised of at least one second mobile device, the list being based on a likelihood that the at least one second mobile device is one that the user of the first mobile device will initiate the telephone call to in order to continue the conversation held with the user of the at least one second mobile device while the at least one second mobile device was detected as being in proximity to the first mobile device.

7. The method as in claim 6, where entries in the list are ordered using at least one metric comprised of one or more of: an amount of time that the at least one second mobile device was detected as being in proximity to the first mobile device; how long it has been since a particular second mobile device was detected as being in proximity to the first mobile device; a frequency of calling a particular second mobile device; a total number of times that a particular second mobile device was called; and a received signal strength determined when detecting the particular mobile device via the wireless link.

8. A computer-readable memory medium that stores program instructions the execution of which results in operations that comprise:
detecting via a wireless link a presence of at least one second mobile device within proximity of a first mobile device, where the detected at least one second mobile device is associated with a user who is involved in a conversation with a user of the first mobile device;
storing identification-related information received from the at least one second mobile device in a memory of the first mobile device; and
initiating a call to the at least one second mobile device using the stored identification-related information when the at least one second mobile device is no longer within proximity of the first mobile device.

9. The computer-readable memory medium of claim 8, where the stored identification-related information comprises a telephone number.

10. The computer-readable memory medium of claim 8, where the stored identification-related information comprises information needed to access a database of contact information to enable the initiation of the telephone call.

11. The computer-readable memory medium of claim 10, where the database comprises part of the first mobile device, or where the database is external to the first mobile device and is accessed through a communication network.

12. The computer-readable memory medium of claim 8, where the stored identification-related information comprises cryptographically signed, timestamped anonymous contact information that is transmitted to a remote server to enable the initiation of the telephone call without divulging direct contact information of the user of the second mobile device to the user of the first mobile device.

13. The computer-readable memory medium of claim 8, where initiating comprises determining a list comprised of at least one second mobile device, the list being based on a likelihood that the at least one second mobile device is one that the user of the first mobile device will initiate the telephone call to in order to continue the conversation held with the user of the at least one second mobile device while the at least one second mobile device was detected as being in proximity to the first mobile device.

14. The computer-readable memory medium of claim 13, where entries in the list are ordered using at least one metric comprised of one or more of: an amount of time that the at least one second mobile device was detected as being in proximity to the first mobile device; how long it has been since a particular second mobile device was detected as being in proximity to the first mobile device; a frequency of calling a particular second mobile device; a total number of times that a particular second mobile device was called; and a received signal strength determined when detecting the particular mobile device via the wireless link.

15. An apparatus, comprising:
a data processor;
a user interface;
a first communication interface through which a call may be made;
a second communication interface; and
a memory that stores information received through the second communication interface, the information being received from at least one mobile communication device when disposed in proximity to said apparatus;
said data processor is configurable to operate with said user interface, said memory and said first communication interface to initiate a call to the at least one mobile communication device using the stored information to continue a conversation between a user of the apparatus and a user of the at least one mobile communication device when the at least one mobile communication device is no longer disposed in proximity to the apparatus.

16. The apparatus as in claim 15, where the stored information comprises at least one of a telephone number and information needed to access a database of contact information to enable the initiation of the call.

17. The apparatus as in claim 16, where the database is stored in said memory, or where the database is stored external to said apparatus and is accessed through said first communication interface.

18. The apparatus as in claim 15, where the stored information comprises cryptographically signed, timestamped anonymous contact information that is transmitted to a remote server through said first communication interface to enable the initiation of the call without divulging direct contact information of the user of the second mobile device to the user of the first mobile device.

19. The apparatus method as in claim 15, where said data processor is configurable to create a list comprised of at least one mobile communication device, the list being created using the information received from the at least one mobile communication device when disposed in proximity to said apparatus, the list being presented using said user interface and entries in the list being ordered based on a likelihood that the at least one mobile communication device is one that the user of the apparatus will initiate the call to in order to continue the conversation held with the user of the at least one mobile communication device.

20. The apparatus as in claim 19, where entries in the list are ordered using at least one metric comprised of one or more of: an amount of time that the at least one mobile communication device was detected as being in proximity to said apparatus; how long it has been since a particular mobile communication device was detected as being in proximity to said apparatus; a frequency of calling a particular mobile communication device; a total number of times that a particular mobile communication device was called; and a received signal strength determined by said second communication interface.

21. An apparatus, comprising:
means for detecting via a wireless link a presence of at least one second mobile device within proximity of a first mobile device;
means for storing identification-related information received from the at least one second mobile device in a memory of the first mobile device; and
means for initiating a call to the at least one second mobile device via a communications network using the stored identification-related information such that a user of the apparatus is enabled to continue a face-to-face conversation conducted with a user of the of at least one second mobile device after the user of the second mobile device is no longer in proximity to the user of the apparatus.

22. The apparatus as in claim 21, where the stored identification-related information comprises at least one of a telephone number and information needed to access a database of contact information to enable the initiation of the telephone call, where said database is stored in at least one of said memory means or external to said apparatus and is accessed through said communication network.

23. The apparatus as in claim 22, where the stored identification-related information comprises cryptographically signed, timestamped anonymous contact information that is transmitted to a remote server to enable the initiation of the telephone call without divulging direct contact information of the user of the second mobile device to the user of the first mobile device.

24. The apparatus as in claim 21, further comprising means for determining a list comprised of at least one second mobile device, the list being based on a likelihood that the at least one second mobile device is one that a user of said apparatus will initiate the call to, where entries in the list are ordered using at least one metric comprised of one or more of: an amount of time that the at least one mobile communication device was detected as being in proximity to said apparatus; how long it has been since a particular mobile communication device was detected as being in proximity to said apparatus; a frequency of calling a particular mobile communication device; a total number of times that a particular mobile communication device was called; and a received signal strength determined by said detecting means.

25. The apparatus of claim 21, where said detecting means comprises a low power radio frequency link, and where said communications network is comprised of a cellular radio frequency phone network.
